(19) United States
(12) Patent Application Publication
(10) Pub. No.: US 2008/0056408 A1
(43) Pub. Date: Mar. 6, 2008

(54) A RECEIVER ARCHITECTURE

(76) Inventor: Amir Mezer, Haifa (IL)

Correspondence Address: SCHWEGMAN, LUNDBERG & WOESSNER, P.A., P.O. BOX 2938, MINNEAPOLIS, MN, 55402, US

(21) Appl. No.: 11/468,366

(22) Filed: Aug. 30, 2006

(51) Int. Cl. H04L 27/00

(52) U.S. Cl. 375/316

(57) ABSTRACT

Apparatus, systems, and methods are provided to provide analog pre-equalization to a signal received from a communication channel prior to analog-to-digital conversion of the signal.

### TECHNICAL FIELD

Embodiments of the invention relate generally to communication architectures.

### BACKGROUND

A communication network typically includes equipment from various vendors sending data and information among the equipment in the network. To promote interoperability among vendor equipment, an open systems interconnection (OSI) reference model is a widely accepted structure to provide a standard architecture for such interoperability. Models similar to an OSI reference model may include a physical (PHY) layer at the lowest structure layer followed by a data link layer. The physical layer deals with the transmission of bit streams over a physical medium. It also deals with the mechanical, electrical, functional, and procedural characteristics to access the physical medium. Above the data link layer, the model may include higher order layers such as a network layer, a transport layer, a session layer, a presentation layer, and an application layer. The layers may also include sub-layers.

Channels in a communication network may typically experience channel distortion. This channel distortion may result in intersymbol interference (ISI), which essentially is the spreading of a signal pulse outside its allocated time interval causing interference with adjacent pulses. If a communication channel is uncompensated with respect to its intersymbol interference, high error rates may result. Various methods and designs are used for compensating or reducing intersymbol interference in a signal received from a communication channel. The compensators for reconstructing a signal that has such intersymbol interference are known as equalizers. An equalizer may have two parts, a feed forward equalizer (FFE) and a decision feedback equalizer (DFE). These equalizers may be configured in a PHY layer to combat intersymbol interference such that a signal received from a communication channel may be reconstructed with only small residual intersymbol interference. Various equalization methods include maximum-likelihood (ML) sequence detection, linear filters with adjustable coefficients, and decision-feedback equalization (DFE).

To provide 10 Gigabit/second (10 G) communications over conventional unshielded or shielded twisted pair cables between apparatus from various vendors, standards are being created from work by a task force of the Institute of Electrical and Electronics Engineers (IEEE). A 10 GBase-T standard is currently being developed by IEEE 802.3an, a subgroup of the IEEE 802.3 group. On Jun. 8, 2006, the IEEE Standards Association (IEEE-SA) Standards Board approved the preliminary standard, IEEE P802.3an. Upon publication, the approved IEEE 802.3an standard may be known as IEEE Std. 802.3an™-2006.

The 10 G Ethernet standard relates to the transmitter, the transmitter parameters, the channels over which signals propagate, and the operating environment. Each vendor is expected to build apparatus in order to meet the performance requirements that are defined in the standard.

### BRIEF DESCRIPTION OF THE DRAWINGS

FIG. 1 shows a block diagram of an embodiment of an apparatus having an analog pre-equalizer.

FIG. 2 shows a flow diagram of a method that includes performing pre-equalization of a signal in the analog domain.

FIG. 3 shows a block diagram of an embodiment of a receiver having an analog pre-equalizer.

FIG. 4 shows a block diagram of an embodiment of an analog pre-equalizer.

FIG. 5 shows a comparison of feed-forward equalization with an embodiment of an analog pre-equalizer and without an analog pre-equalizer.

FIG. 6 shows a comparison of decision feedback equalization with an embodiment of an analog pre-equalizer and without an analog pre-equalizer.

FIGS. 7A-7B show a total receiver frequency response of a receiver having an embodiment of an analog pre-equalizer.

FIG. 8 shows a block diagram of an embodiment of a receiver having an analog pre-equalizer with an integrated filter.

FIG. 9 illustrates a block diagram of an embodiment of a structure of communication system incorporating an analog pre-equalizer.

FIG. 10 illustrates a block diagram of an embodiment of a system having an embodiment of a receiver with an analog pre-equalizer.

### DETAILED DESCRIPTION

The following detailed description refers to the accompanying drawings that show, by way of illustration, specific details and embodiments in which the invention may be practiced. These embodiments are described in sufficient detail to enable those skilled in the art to practice embodiments of the present invention. Other embodiments may be utilized and structural, logical, and electrical changes may be made without departing from the scope of the inventive subject matter. The various embodiments disclosed herein are not necessarily mutually exclusive, as some embodiments can be combined with one or more other embodiments to form new embodiments. The following detailed description is, therefore, not to be taken in a limiting sense.

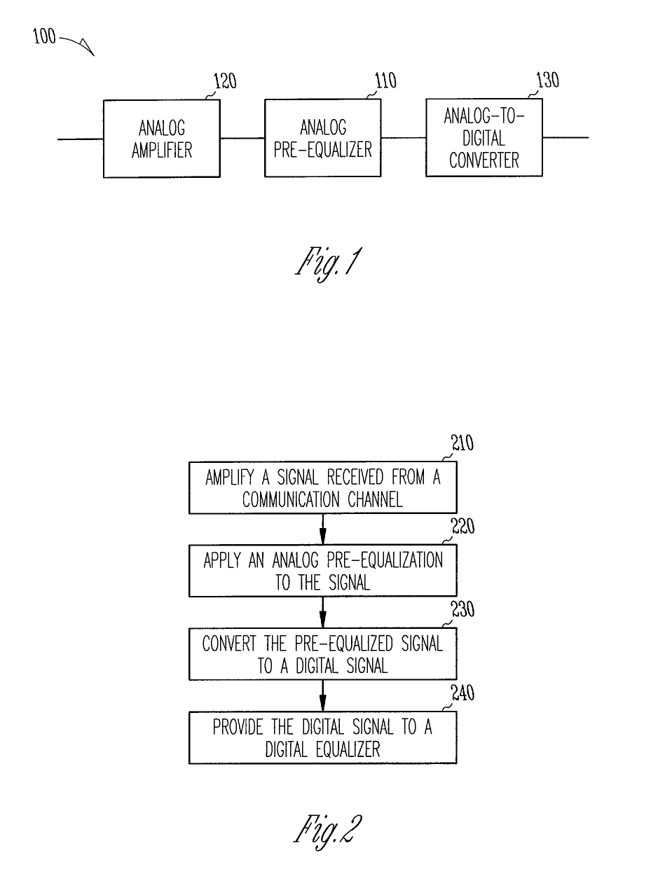

FIG. 1 shows a block diagram of an embodiment of an apparatus 100 having an analog pre-equalizer 110. Apparatus 100 may include an analog amplifier 120 and an analog-to-digital (A/D) converter 130. The output signal from A/D converter 130 is a digital signal that may be further processed. Such additional processing may include equalization of the digital signal and/or amplification of the digital signal. Associated with A/D converter 130 is the input of noise to the processing of a signal. For a perfect analog-to-digital process, the existing noise would be limited to quantization noise. However, for a practical analog-to-digital conversion, there are additional noise contributors. As a result of these additional noise contributors, the overall A/D performance is determined by the combination of all these noises.

In an embodiment, pre-equalizer 110 may be used to reduce the amplification of noise contributions in processing the digital signal provided at the output of A/D converter 130. The overall amplification in apparatus 100 associated with an analog signal received by apparatus 100 and processed as a digital signal by apparatus 100 may be designed as a concatenation of amplifications with the largest gain in amplifications located at the beginning of the chain at analog amplifier 120.

In an embodiment, pre-equalizer 110 may be constructed to condition the signal to perform in the analog domain a portion of the filtering associated with the digital processing of the signal following the A/D converter 130. The pre-equalization may be provided to shape a received analog signal prior to A/D conversion to reduce the amount of noise contributed in the A/D conversion, allowing reduction of gain used in the digital processing following the A/D conversion. For a set gain factor for apparatus 100 in an application, analog pre-equalizer 110 allows the gain of analog amplifier 120 to be increased while decreasing the digital gain of apparatus 100, such that the gain factor of apparatus 100 is the same as used in the same application without an analog pre-equalizer. The architecture of FIG. 1 using an analog pre-equalizer may be used in various embodiments to reduce the amplification of the noise introduced by A/D converter 130. Such an architecture may result in enhanced performance, or, alternatively, maintain the same performance with a reduced performance in A/D converter 130. Since the A/D conversion may be a power consumer in the system having apparatus similar to 100, and since the A/D converter power is monotonically proportional to its performance, the overall system power consumption may be decreased using analog pre-equalizer 110.

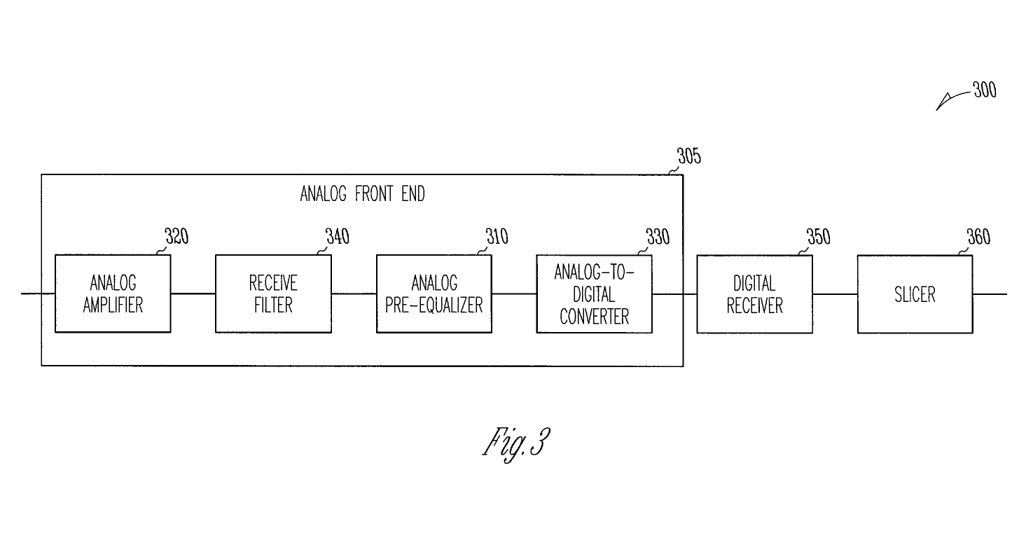

FIG. 2 shows a flow diagram of a method that includes performing pre-equalization of a signal in the analog domain. At 210, a signal received from a communication channel is amplified. The signal may be further processed. At 220, an analog pre-equalization is applied to the signal. The signal is pre-equalized in the analog domain and may be further processed. At 230, the pre-equalized signal is converted to a digital signal. At 240, the digital signal is provided to a digital equalizer. The digital equalizer may be part of a digital receiver.

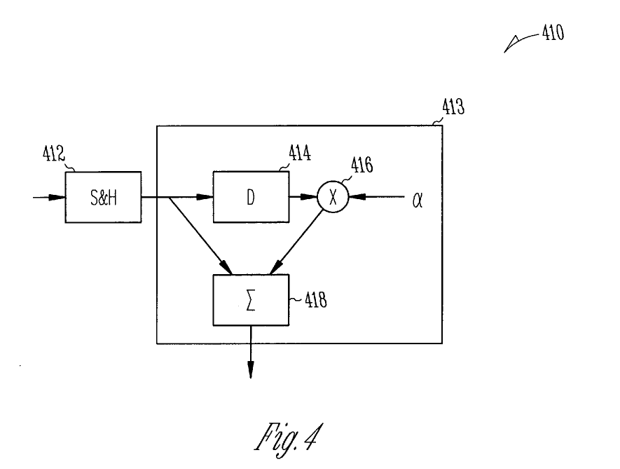

FIG. 3 shows a block diagram of an embodiment of a receiver 300 having an analog pre-equalizer 310. Receiver 300 operates at the physical (PHY) layer of a communication architecture. Receiver 300 may include an analog amplifier 320, a receive filter 340, and an analog-to-digital converter 330 in addition to analog pre-equalizer 310. Analog amplifier 320, receive filter 340, analog pre-equalizer 310, and A/D converter 330 may be part of an analog front end 305 to a digital receiver 350. Digital receiver 350 may be realized as a feed-forward equalizer 350 or may include a feed-forward equalizer. Digital receiver 350 may be realized as, or as part of, a digital signal processor (DSP). A DSP may be realized as a chip. A chip is a semiconductor device. Separate semiconductor devices forming part of a family of chips are called a chip set. A chip set may be realized as a group of microchips designed to work and to be sold as a unit in performing one or more related functions. The output of feed-forward equalizer 350 may be provided to a slicer 360. A slicer is a unit in which a decision is made as to which symbols were sent by a remote transmitter, where the symbols are propagated in a transmission medium that provides the signal input to analog front end 305.

In an embodiment, the architecture of FIG. 3 may be used for a 10GBase-T receiver design, where such an architecture may be based on the addition of an analog pre-equalizer into a 10GBase-T receiver design. Typical proposals for standards related to 10 G Ethernet relate to defining the transmitter, transmitter parameters, and channels over which information signals operate and their associated environment. Vendors are expected to build machines that meet the performance requirements that are defined in the applicable standards. In the design of a conventional architecture for a 10GBase-T communications system, the derived specifications, in order to meet the associated requirements for the proposed 802.3an standard, are such that typical receivers result in an A/D converter with a performance figure of merit of approximately 9 effective number of bits (ENOB) @800 MHz. There is a general, but informal, consensus amongst vendors designing receivers for 10 GBase-T operation, that this is the appropriate number. Typically, such a high-end A/D design results in significantly high power consumption and accounts for a large part of the analog power consumption in the complete 10 GBase-T solution for a receiver.

In an embodiment, an architecture having an analog pre-equalizer such as that of FIG. 3 relieves the requirements from the A/D design, resulting in a lower power solution. In addition, the architecture having an analog pre-equalizer may provide enhanced system performance and lower power consumption in other elements in the receiver system. Analog pre-equalizer 310 may perform part of the equalization task of the digital equalizer of digital receiver 350. In an embodiment, analog pre-equalizer 310 may be designed such that it allows the gain of the digital receiver 350 to be significantly reduced.

In an embodiment, an architecture for a receiver system having a digital receiver with an analog front end may be structured with as much amplification as possible in the front end of the receiving chain of the receiver system. In an embodiment, the architecture of FIG. 3 may be structured to significantly reduce the amplification of the noise introduced by the A/D converter 330, which is one of the main noise contributors in receiver 300. A/D noise has several components. For a perfect A/D, only quantization noise exists. For a practical A/D converter, there are additional noise contributors. The overall A/D performance is determined by the combination of all these noises. Receiver 300 may be structured to maintain receiver system performance with a relaxed A/D requirement. In an embodiment, analog amplifier 320 has a gain, G_{ANALOG}, and digital receiver 350 may be a digital equalizer, such as a feed-forward equalizer having a gain, G_{FFE}. For a desired total gain of receiver 300, G_{FFE} may be decreased, while G_{ANALOG} is increased to maintain the desired total gain of receiver 300 in order to provide the correct levels for slicer 360. In an embodiment, incorporation of analog pre-equalizer 310 in analog front end 305 may relieve A/D design requirements.

The architecture of example embodiment illustrated in FIG. 3 may provide low power solution for a receiver system such as, but not limited to, a 10GBase-T receiver system. In a conventional architecture, the typical A/D converter for a receiver architecture is being designed to 9 ENOB @800 MHz, resulting in excessive power consumption. In an embodiment, the A/D design of the receiver architecture 300 may be relieved by approximately 0.5 to 1.0 ENOB, resulting in lower power consumption of A/D converter 330. Since the A/D conversion is a significant power consumer in receiver 300, the overall receiver system power consumption may significantly decrease. Further, incorporating analog pre-equalizer 310 prior to A/D conversion, it is possible to take benefit of the enhanced performance and relaxed internal requirements of other elements in the system, not only A/D converter 330. In an embodiment, with all channels passing through analog pre-equalizer 310, some are significantly shortened in duration at digital receiver 350, which may be realized in a DSP. This may result in less hardware needed to deal with the channels. Because of the lower norm of the DFE in a system with an analog pre-equalizer, the number of expansions due to a precoder, such as a Tomlinson-Harashima precoder (THP), in the communication system may be significantly reduced. In a system with a THP, when observing the FFE output, the desired signal appears in addition to an expansion term, for example s+M*L, where s is the desired signal, L is the level of a single expansion, and M is the number of expansions. After the modulo operation, the expansion disappears, that is, modulo(s+M*L)=s. The norm of the DFE (the sum of the absolute value of the coefficients) directly affects the expansion factor M. Since the norm may be made smaller in a system with an analog pre-equalizer, the expansion factor is smaller. For algorithms that use the FFE output before the modulo operation, it may be desirable to have a low expansion factor. This can enhance performance of algorithms in the DSP, for example, the timing recovery algorithm.

In operation, DFE coefficients are passed during a training phase to the link partner in the communication channel. This allows the link partner to place the DFE coefficients in the precoder, such as a THP, at the transmitter at the transmit side of the communication channel. Since these are equalizer coefficients, the values of these equalizer coefficients are correlated to the link partner's receiver architecture that includes analog pre-equalizer 310. Analog pre-equalizer 310 may be realized in accordance with various embodiments.

FIG. 4 shows a block diagram of an embodiment of an analog pre-equalizer 410. In the example embodiment, analog pre-equalizer 410 includes a sample-and-hold (S&H) unit 412 and a delay-and-adjust unit 413 in the form of a 1-αD unit in which D represents an amount of delay and α is a scaling factor. The S&H unit 412 may be an analog block that samples and holds the analog value. Delay-and-adjust unit 413 may include a delay unit 414, a multiplying unit 416 that scales the delayed signal by factor of α, and a summer 418 that operates on a sample and subtracts a delayed sample scaled by factor α. The delay and the factor α may be adjustable. In an embodiment, the delayed sample may be the previous sample. As an example of the operation of analog pre-equalizer 410, for signals . . . , x₁, x₂, x₃, x₄ . . . input to analog pre-equalizer 410 at the input to S&H unit 412, the outputs from summer 418 are . . . , x₂−αx₁, x₃−αx₂, x₄−αx₃, where αxᵢ is the product of α and xᵢ. The values of α may be associated with characteristics of the corresponding communication channel. In an embodiment, the values of α are associated with the channel length of the corresponding communication channel. The values of α may change with channel length. In an embodiment, α=0.8 is applied for a channel having a length of approximately 100 meters (m).

In an embodiment, a 1-αD format provides an analog pre-equalizer mechanism that operates at the clock rate of the A/D converter, such as A/D converter 330 of FIG. 3. In an embodiment, analog pre-equalizer 410 may operate at an A/D clock rate that runs at 800 MHz. Analog pre-equalizer 410 provides a sample and hold and a translation of the inherent analog value into the digital value. This provides shaping of the signal that performs part of the equalization task. In an embodiment, analog pre-equalizer 410 provides filtering of the received signal as a shaping filter. Using a 1-αD format, a resultant equalizer provides for lower amplification in which the A/D noise is amplified less than in a conventional system. This may relax design criteria for the analog-to-digital converter in the receiver architecture. In an embodiment, analog pre-equalizer 410 reduces A/D design requirements for a 10 GBase-T receiver.

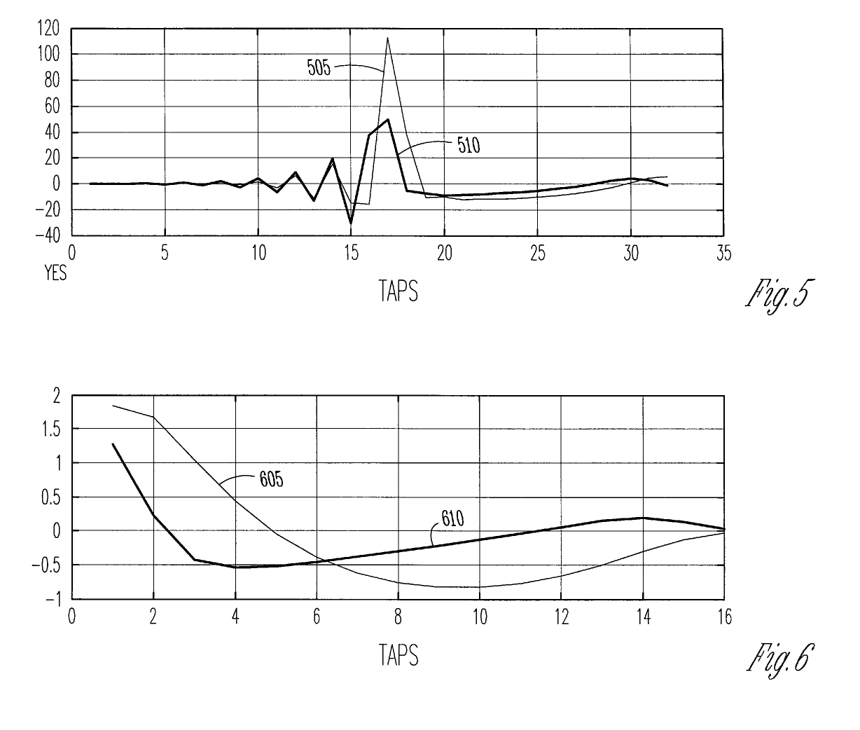

FIG. 5 shows a comparison of feed-forward equalization with an embodiment of an analog pre-equalizer and without an analog pre-equalizer for a channel length of 100 m. Curve 505 is for a receiver designed without an analog pre-equalizer and curve 510 is for a receiver designed with an embodiment of an analog pre-equalizer. Curves 505 and 510 show the differences in gain at the digital receiver for the two different receiver configurations, in which the overall gain of the receiver configurations are maintained at the same level. In FIG. 5, the horizontal axis is shown in terms of the number of filter taps at 800 MHz. The vertical axis is in arbitrary units that represent the amplification between the A/D conversion in the analog front end and the slicer that follows the feed-forward equalization in order to reconstruct the signal received.

In various embodiments, part of the amplification task is moved to the analog front end with the use of an analog pre-equalizer, where the total amplification remains the same such that the amplification of the feed forward equalizer becomes lower. Moving part of the equalizer into the analog section realized in the analog pre-equalizer relaxes the A/D specifications. FIG. 5 demonstrates that use of an analog pre-equalizer with increased gain in the analog amplifier of an analog front end allows for low gain in a feed-forward equalizer rather than a high gain associated with a receiver architecture without an analog pre-equalizer.

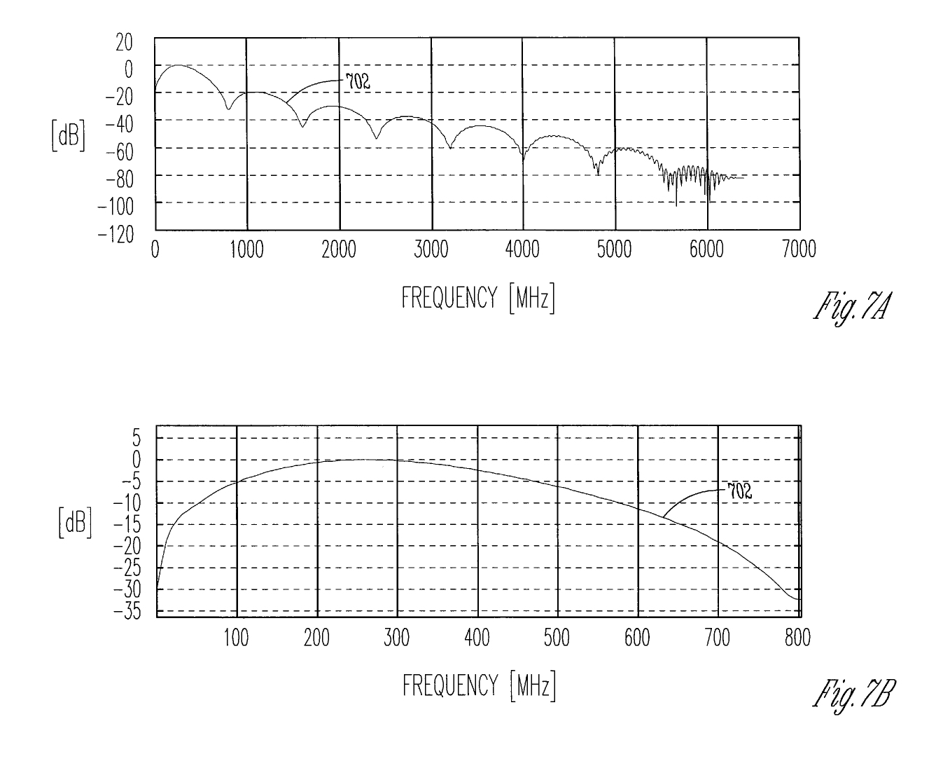

FIG. 6 shows a comparison of decision feedback equalization with an embodiment of an analog pre-equalizer and without an analog pre-equalizer for a channel length of 100 m. The vertical axis shows the values of symbols with respect to the number of filter taps to provide minimum mean square error (MMSE) equalization. Curve 605 is for a receiver architecture without an analog pre-equalizer and curve 610 is for a corresponding receiver architecture with the addition of an analog pre-equalizer.

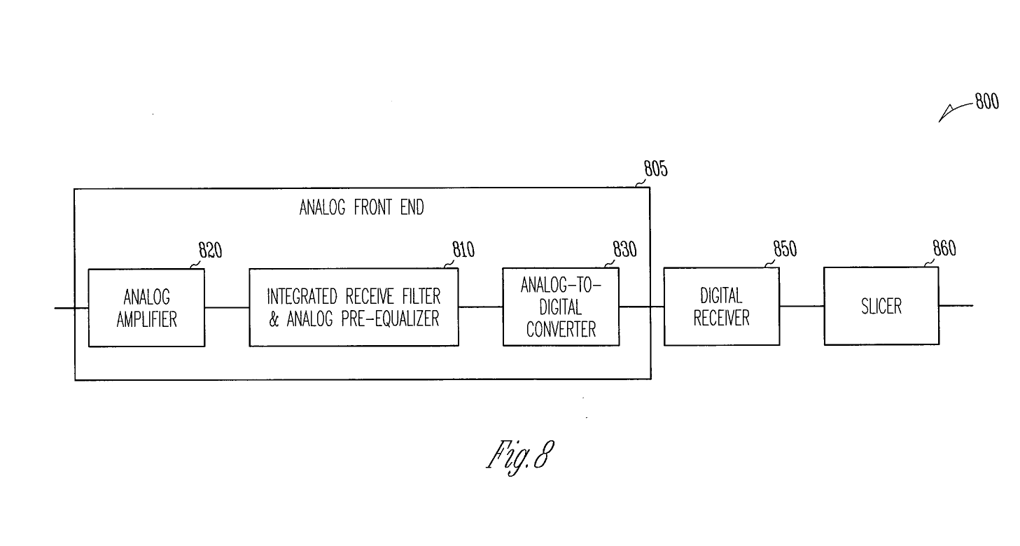

Typically, a 10 GBase-T communication channel itself provides a low pass filter mechanism. In a conventional receiver system, a feed-forward equalizer acts as a shaping filter. In an embodiment, part of the shaping filter of the feed-forward equalizer is placed in the analog domain with incorporation of the analog pre-equalizer in the analog front end of a receiver architecture. In an embodiment, an analog pre-equalizer provides a mechanism that filters out noise at an A/D clock rate of 800 MHz. This allows A/D noise to pass through to the FFE with low amplification. To maintain the total amplification at more or less the same level as without an analog pre-equalizer, a higher analog amplification may be used in the analog front end of the receiver. FIGS. 7A-7B show a total receiver frequency response 702 of a receiver having an embodiment of an analog pre-equalizer. FIG. 7B shows response 702 of FIG. 7A over a portion of the frequency range of FIG. 7A.

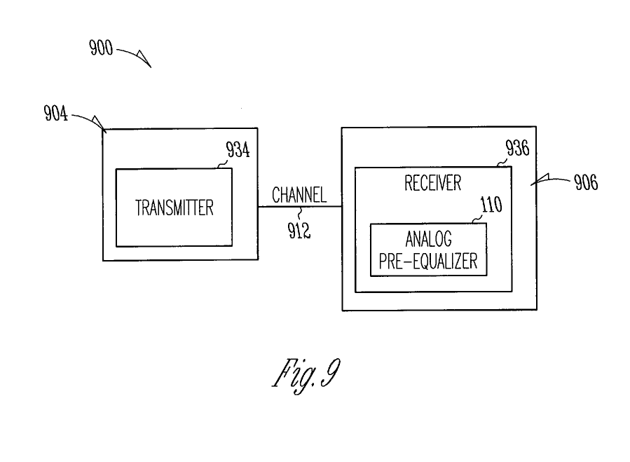

FIG. 8 shows a block diagram of an embodiment of a receiver 800 having an analog pre-equalizer with integrated filter 810. Receiver 800 may include an analog amplifier 820 and an A/D converter 830 in addition to analog pre-equalizer with integrated filter 810. Analog amplifier 820, A/D converter 830, and analog pre-equalizer with integrated filter 810 may be part of an analog front end 805 to a digital receiver 850 that provides an input to a slicer 860. Digital receiver 850 may be realized as a feed-forward equalizer 850 or include a feed-forward equalizer. Digital receiver 850 may be realized as, or as part of, a DSP.

Inclusion of analog filters in communications systems is common practice. These are usually placed for numerous reasons, typically, as anti-aliasing filters before sampling the analog signals. A filter may also be placed in a design for a receiver in order to shape a sampled signal in a digital signal processor following A/D conversion.

FIG. 9 illustrates a block diagram of an embodiment of a structure of communication system 900 incorporating an analog pre-equalizer 910. Communication system 900 may comprise first and second network nodes 904 and 906, respectively. Network nodes 904 and 906 may be coupled to a channel 912 over which they communicate. Channel 912 may be a multiple-input/multiple output (MIMO) channel. Network nodes 904 and 906 may each include a transmitter 934 and a receiver 936 (though only one transmitter and one receiver are shown in FIG. 9). Receiver 936 may include an embodiment of an analog pre-equalizer 910 similar to embodiments discussed herein. The first and second network nodes 904, 906 each may represent processing systems having a physical layer entity (PHY) arranged to operate in accordance with 10 GBase-T as defined by the IEEE 802.3an series of standards, for example. The 10GBase-T PHY may interface with, for example, a 10 G media access control (MAC) and Gigabit Media Independent Interface (XGMII) in the IEEE architecture. The 10 GBase-T PHY may comprise part of a network interface card (NIC), for example. Nodes 904, 906 may comprise any processing system and/or communications device suitable for use with a 10 GBase-T device. For example, nodes 904, 906 may be implemented as a pair of switches, a pair of routers, a pair of servers, a switch and a router, a switch and a server, a server and a router, and so forth. In addition, nodes 904, 906 also may be part of a modular system in which 10 GBase-T is the high-speed connection for the system. Further examples for nodes 904, 906 may include high-end servers, supercomputers, clusters, grid computing, workgroup switch uplinks, aggregation uplinks, storage systems, and so forth. The embodiments are not limited in this context.

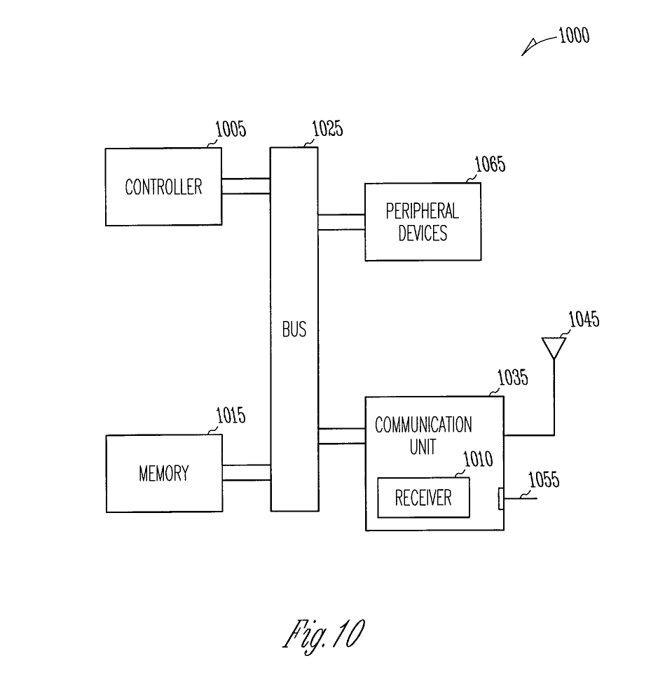

FIG. 10 illustrates a block diagram of an embodiment of a system 1000 having an analog pre-equalizer in a receiver application. System 1000 may include a controller 1005, a memory 1015, and a bus 1025, where bus 1025 provides electrical connectivity between controller 1005 and memory 1015 and between controller 1005 and a communication unit 1035. Bus 1025 may be a parallel bus. Bus 1025 may be a serial bus. Communication unit 1035 may include an embodiment of a receiver 1010 having an analog pre-equalizer for a wide range of channel lengths. The analog pre-equalizer may be realized in a number of different forms as taught herein, where the analog pre-equalizer may include adjustable features or parameters, such as a scaling factor, based on the communication channel length. Communication unit 1035 may include a transmitter for bi-directional communication over a network. Communication unit 1035 may couple to a wired network or a wireless network. Alternatively, communication unit 1035 may include a network interface to couple to a wired network and to a wireless network. A wired network may include a network having wire channels, fiber optic channels, and/or co-axial channels.

An embodiment may include an additional peripheral device or devices 1065 coupled to bus 1025. Bus 1025 may be compatible with peripheral component interconnect (PCI) or with PCI Express. In an embodiment, communication unit 1035 may include a network interface card. In an embodiment, communication unit 1035 may include a communications device suitable for use with a 10GBase-T device. Communication unit 1035 may include a connection to a wired network. The connection to the wired network may be configured to connect to a cable 1055. The connection may be configured to connect to an unshielded twisted pair cable. The connection may be configured to connect to a shielded twisted pair cable. In a wireless embodiment, communication unit 1035 may be coupled to an antenna 1045. In an embodiment, antenna 1045 may be a substantially omnidirectional antenna. System 1000 may include, but is not limited to, information handling devices, wireless systems, telecommunication systems, fiber optic systems, electro-optic systems, and computers.

In an embodiment, controller 1005 is a processor. Memory 1015 may include any form of computer-readable medium that has computer-executable instructions that may provide control of one or more elements of system 1000. Peripheral devices 1065 may also include displays, additional storage memory, or other control devices that may operate in conjunction with controller 1005. Alternatively, peripheral devices 1065 may include displays, additional storage memory, or other control devices that may operate in conjunction with controller 1005, communication unit 1035, and/or memory 1015.

In a wireless arrangement in which the transmission medium between transmitter and receiver is relatively steady or slowly varying, the channel characteristics may be modeled or determined. With a given wireless channel model, analog pre-equalizers features may be determined for specific distance intervals within a specified distance range. Various embodiments for constructing a receiver having analog pre-equalization may be implemented for a wireless application having a relatively steady or slowly varying transmission medium.

Although specific embodiments have been illustrated and described herein, it will be appreciated by those of ordinary skill in the art that any arrangement that is calculated to achieve the same purpose may be substituted for the specific embodiments shown. It is to be understood that the above description is intended to be illustrative, and not restrictive, and that the phraseology or terminology employed herein is for the purpose of description and not of limitation. Combinations of the above embodiments and other embodiments will be apparent to those of skill in the art upon studying the above description.

What is claimed is:

1. A method comprising:
amplifying a signal received from a communication channel, the communication channel having a channel length;
applying an analog pre-equalization to the signal, after amplifying the signal, to provide a pre-equalized signal, the pre-equalization correlated to a characteristic of the communication channel;
converting the pre-equalized signal to a digital signal; and
providing the digital signal to a digital equalizer.

2. The method of claim 1, wherein applying an analog pre-equalization to the signal includes conditioning the signal to perform a portion of shaping filtering associated with the digital equalizer.

3. The method of claim 1, wherein applying an analog pre-equalization to the signal includes generating the pre-equalized signal as a difference between a sample of the signal and a previous sample of the signal scaled by a numerical factor less than one.

4. The method of claim 3, wherein generating the pre-equalized signal includes applying a numerical factor of 0.8.

5. The method of claim 4, wherein applying a numerical factor of 0.8 includes applying the numerical factor of 0.8 correlated to the communication channel having a cable with a cable length of 100 meters.

6. The method of claim 3, wherein generating the pre-equalized signal includes applying a numerical factor correlated to the channel length.

7. The method of claim 1, wherein converting the pre-equalized signal to a digital signal includes using an analog-to-digital converter having an effective number of bits of 8.5 or less at 800 megahertz to provide performance substantially equivalent to analog-to-digital conversion of about 9 effective number of bits without applying the analog pre-equalization to the signal.

8. An apparatus including:
an amplifier to amplify a signal received from a communication channel;
an analog pre-equalizer coupled to the amplifier and responsive to at least a portion of the signal amplified by the amplifier, the analog pre-equalizer correlated to a characteristic of the communication channel; and
an analog-to-digital converter coupled to the analog pre-equalizer.

9. The apparatus of claim 8, wherein the analog pre-equalizer includes a sample-and-hold circuit.

10. The apparatus of claim 9, wherein the sample-and-hold circuit is arranged to generate a pre-equalized signal as a difference between a sample of the signal and a previous sample of the signal scaled by a numerical factor less than one.

11. The apparatus of claim 10, wherein the numerical factor includes a numerical factor of 0.8.

12. The apparatus of claim 10, wherein the numerical factor includes a numerical factor correlated to the communication channel.

13. The apparatus of claim 12, wherein the communication channel has a channel length and the numerical factor is correlated to the channel length.

14. The apparatus of claim 8, wherein the apparatus includes a filter to couple the amplifier to the analog pre-equalizer.

15. The apparatus of claim 8, wherein the analog pre-equalizer includes a filter integrated with the analog pre-equalizer.

16. The apparatus of claim 8, wherein the apparatus includes:
a digital equalizer coupled to the analog-to-digital converter; and
a slicer coupled to the digital equalizer.

17. The apparatus of claim 8, wherein the analog pre-equalizer is integral to a 10 GBase-T receiver.

18. A system comprising:
a cable, the cable having a twisted pair configuration; and
a receiver coupled to the cable, the receiver including:
an amplifier to amplify a signal received from the cable;
an analog pre-equalizer to operate on the signal amplified by the amplifier,
the analog pre-equalizer correlated to a characteristic of the cable;
an analog-to-digital converter coupled to the analog pre-equalizer; and
a digital equalizer coupled to an output of the analog-to-digital converter.

19. The system of claim 18, wherein the analog pre-equalizer includes a sample-and-hold circuit arranged to generate a pre-equalized signal as a difference between a sample of the signal and a previous sample of the signal scaled by a numerical factor less than one.

20. The system of claim 19, wherein the numerical factor includes a numerical factor correlated to a communication channel that includes the cable and the receiver.

21. The system of claim 19, wherein the cable has a cable length and the numerical factor is correlated to the cable length.

22. The system of claim 18, wherein the receiver includes a filter to couple the amplifier to the analog pre-equalizer.

23. The system of claim 18, wherein the analog pre-equalizer includes a filter integrated with the analog pre-equalizer.

24. The system of claim 18, wherein the system includes a network interface card on which the receiver is disposed.

25. The system of claim 18, wherein the receiver includes a 10GBase-T receiver.

26. The system of claim 18, wherein the receiver includes a receiver arranged with a Tomlinson-Harashima precoder as a communication link partner.
